(19) United States
(12) Patent Application Publication
(10) Pub. No.: US 2025/0062382 A1
(43) Pub. Date: Feb. 20, 2025

(54) FUEL CELL MODULE

(71) Applicants: Hyundai Motor Company, Seoul (KR); Kia Corporation, Seoul (KR)

(72) Inventor: Kyung Ho Kim, Seongnam-si (KR)

(21) Appl. No.: 18/491,419

(22) Filed: Oct. 20, 2023

(30) Foreign Application Priority Data
Aug. 18, 2023 (KR) 10-2023-0108579

(51) Int. Cl. H01M 8/248; H01M 8/0276; H01M 8/2475

(52) U.S. Cl. CPC H01M 8/248; H01M 8/0276; H01M 8/2475

(57) ABSTRACT

In an embodiment, a fuel cell module can include a fuel cell stack, an endplate configured to cover an end of the fuel cell stack based on a stacking direction of the unit cells, a clamp member configured to surround the fuel cell stack and support the fuel cell stack, an enclosure configured to surround the fuel cell stack and the clamp member, and an elastic member provided to be elastically compressible between the end of the endplate and the enclosure based on the stacking direction of the unit cells, wherein the elastic member is configured to define a variable volume space between the end of the endplate and the enclosure such that the variable volume varies depending on a change in volume of the fuel cell stack.

### CROSS-REFERENCE TO RELATED APPLICATIONS

This application claims the benefit of Korean Patent Application No. 10-2023-0108579, filed on Aug. 18, 2023, which application is hereby incorporated herein by reference.

### TECHNICAL FIELD

The present disclosure relates to a fuel cell module.

### BACKGROUND

A fuel cell stack refers to a kind of power generation device that generates electrical energy through a chemical reaction of fuel (e.g., hydrogen), and the fuel cell stack may be configured by stacking several tens or hundreds of fuel cells (unit cells) in series.

The fuel cell may include a membrane electrode assembly (MEA) having an electrolyte membrane configured to allow hydrogen positive ions to move therethrough, and electrodes (catalyst electrode layers) coupled to two opposite surfaces of the electrolyte membrane and configured to enable a reaction between hydrogen and oxygen. The fuel cell may also include gas diffusion layers (GDLs) positioned to be in close contact with two opposite surfaces of the membrane electrode assembly and configured to distribute reactant gases and transfer the generated electrical energy, and separators (bipolar plates) positioned to be in close contact with the gas diffusion layers and configured to define flow paths.

In addition, a pair of endplates is provided and connected by means of a fastening member (clamp member or strap) at two opposite ends of the plurality of fuel cells constituting the fuel cell stack. The fuel cells may be supported by the endplates to maintain surface pressures thereof (a friction contact state may be maintained).

Meanwhile, if surface pressure and fastening force (fastening load) are concentrated on a particular site in the fuel cell stack, the fuel cell stack may be deformed and damaged, and the durability deteriorates. Therefore, it is important to ensure that the surface pressure and fastening force applied to the fuel cell stack need to be as uniform as possible.

However, in the related art, there is a problem in that surface pressure and fastening force (fastening load) are concentrated on a particular site in the fuel cell stack when a volume of the fuel cell stack is changed (a length of the fuel cell stack in a stacking direction of the unit cells is increased). For this reason, it is difficult to apply entirely uniform surface pressure (internal pressure) to the fuel cell stack.

In particular, because the fastening member partially supports a particular site of the endplate in the related art, there is a problem in that a portion, which is not supported by the fastening member (a portion that is not in contact with the fastening member), is deformed (bent) when a volume of the fuel cell stack is changed. For this reason, there is a problem in that it is difficult to apply entirely uniform surface pressure (internal pressure) to the fuel cell stack, and a load is concentrated on a particular site in the fuel cell stack.

Therefore, recently, various studies have been conducted to minimize deformation of and damage to the fuel cell stack and improve safety and reliability, but the study results are still insufficient. Accordingly, there is a need to develop a technology to minimize deformation of and damage to the fuel cell stack and improve safety and reliability.

### SUMMARY

Embodiments of the present disclosure relate to a fuel cell module, and more particularly, to a fuel cell module capable of minimizing deformation of and damage to a fuel cell stack and improving safety and reliability.

An embodiment of the present disclosure can be made in an effort to provide a fuel cell module capable of minimizing deformation of and damage to a fuel cell stack and improving safety and reliability.

An embodiment of the present disclosure can also be made in an effort to apply entirely uniform surface pressure and fastening force to a fuel cell stack.

Among other things, an embodiment of the present disclosure can also be made in an effort to apply entirely uniform surface pressure and fastening pressure to a fuel cell stack when a volume of the fuel cell stack is changed.

An embodiment of the present disclosure can also be made in an effort to improve sealing, waterproof, and dustproof performance while ensuring durability of the fuel cell stack.

An embodiment of the present disclosure can also be made in an effort to improve performance in cooling a fuel cell stack.

The advantages that can be achieved by an embodiment are not limited to the above-mentioned advantages, but also include advantages or effects that may be understood from the solutions or embodiments described below.

To achieve the above-mentioned advantages, an exemplary embodiment of the present disclosure provides a fuel cell module including: a fuel cell stack implemented by stacking a plurality of unit cells; an endplate configured to cover an end of the fuel cell stack based on a stacking direction of the unit cells; a clamp member configured to surround the fuel cell stack and support the fuel cell stack; an enclosure configured to surround the fuel cell stack and the clamp member; and an elastic member provided to be elastically compressible between the end of the endplate and the enclosure based on the stacking direction of the unit cells, the elastic member being configured to define a variable volume space positioned between the end of the endplate and the enclosure and having a volume that varies depending on a change in volume of the fuel cell stack.

This is to minimize deformation of and damage to the fuel cell stack and improve safety and reliability. That is, if surface pressure and fastening force (fastening load) are concentrated on a particular site in the fuel cell stack, the fuel cell stack may be deformed and damaged, and the durability deteriorates. Therefore, it is preferred to ensure that the surface pressure and fastening force applied to the fuel cell stack is as uniform as possible. However, in the related art, there is a problem in that surface pressure and fastening force (fastening load) are concentrated on a particular site in the fuel cell stack when a volume of the fuel cell stack is changed (a length of the fuel cell stack in a stacking direction of the unit cells is increased). For this reason, it is difficult to apply entirely uniform surface pressure (internal pressure) to the fuel cell stack.

In particular, because the fastening member partially supports a particular site of the endplate in the related art, there is a problem in that a portion, which is not supported by the fastening member (a portion that is not in contact with the fastening member), is deformed (bent) when a volume of the fuel cell stack is changed. For this reason, there is a problem in that it is difficult to apply entirely uniform surface pressure (internal pressure) to the fuel cell stack, and a load is concentrated on a particular site in the fuel cell stack.

In contrast, according to an embodiment of the present disclosure, an elastic member is provided between the end of the endplate and the enclosure, which makes it possible to obtain an advantageous effect of applying uniform surface pressure and fastening force to the fuel cell stack.

Among other things, according to an embodiment of the present disclosure, an elastic member is provided between the end of the endplate and the enclosure, such that the elastic member may elastically support the outer surface of the endplate when the fuel cell stack is elastically deformed (a length of the fuel cell stack in the stacking direction of the unit cells increases). Therefore, in an embodiment, it is possible to minimize local deformation (bending deflection) of the endplate and apply uniform surface pressure and fastening pressure to the fuel cell stack.

A clamp member of an embodiment may have various structures capable of fastening the plurality of unit cells.

According to an exemplary embodiment of the present disclosure, a clamp member may include a clamp body configured to cover the outer surface of the fuel cell stack in the stacking direction of the unit cells, and a clamp hook connected to an end of the clamp body, configured to cover an outer surface of the endplate, and directly restrained by the endplate.

An enclosure of an embodiment may have various structures capable of surrounding the fuel cell stack.

According to an exemplary embodiment of the present disclosure, an enclosure may include a first housing configured to surround a part of the fuel cell stack, and a second housing configured to surround another part of the fuel cell stack.

An elastic member of an embodiment may have various structures capable of being elastically compressible and restorable (expandable and contractible) between the end of the endplate and the enclosure.

According to an exemplary embodiment of the present disclosure, an elastic member may include: a first support portion provided to be elastically in contact with the enclosure; a second support portion spaced apart from the first support portion and provided to be elastically in contact with the endplate; and a connection portion configured to connect the first support portion and the second support portion.

An elastic member of an embodiment may be made of various materials in accordance with required conditions and design specifications. According to an exemplary embodiment of the present disclosure, an elastic member may be made of carbon fiber reinforced plastic (CFRP).

According to an exemplary embodiment of the present disclosure, an elastic member may be provided in the form of a continuous ring provided along an edge of the endplate.

According to the embodiment of the present disclosure described above, the elastic member may have the continuous ring shape provided along the edge of the endplate and elastically support the entire edge of the endplate, thereby more effectively suppressing local deformation (bending deflection) of the endplate caused by a change in volume of the fuel cell stack.

According to an exemplary embodiment of the present disclosure, a fuel cell module may include a reinforcement rib provided on the enclosure while corresponding to the elastic member.

As described above, according to an embodiment of the present disclosure, the reinforcement ribs can be provided on the enclosure so as to correspond to the elastic member, such that the structural rigidity of the portion of the enclosure, which is in contact with the elastic member, may be ensured. Therefore, it is possible to obtain an advantageous effect of minimizing deformation of the endplate by using an elastic force of the elastic member and more stably maintaining an arrangement state and elastic supporting performance of the elastic member.

According to an exemplary embodiment of the present disclosure, a fuel cell module may include a sealing member provided between the elastic member and the endplate.

As described above, according to an embodiment of the present disclosure, the sealing member can be provided between the elastic member and the endplate. Therefore, it is possible to obtain an advantageous effect of minimizing a leak of a reactant gas and a coolant through the gap between the elastic member and the endplate and minimizing introduction of foreign substances, such as dust.

According to an exemplary embodiment of the present disclosure, a fuel cell module may include a seating groove provided between the elastic member and the endplate. For example, a seating groove may be provided in one surface of the elastic member that faces the endplate. In another example, a seating groove may be provided in one surface of the endplate that faces the elastic member.

According to an exemplary embodiment of the present disclosure, a fuel cell module may include a guide groove provided in an outer surface of the clamp hook, which faces the elastic member, so as to be continuously connected to the seating groove and configured such that the elastic member is seated in the guide groove.

As described above, according to an embodiment of the present disclosure, the seating groove can be provided between the elastic member and the endplate, and the sealing member can be seated in the seating groove. Therefore, it is possible to obtain an advantageous effect of stably maintaining the arrangement state of the sealing member and stably ensuring the sealing performance.

According to an exemplary embodiment of the present disclosure, a fuel cell module may include vent holes provided in the enclosure so that air may enter or exit the enclosure depending on a change in volume of the fuel cell stack.

As described above, according to an embodiment of the present disclosure, a vent hole can be provided in the enclosure, such that an effect of cooling the fuel cell stack depending on a change in volume of the fuel cell stack may be provided. Therefore, it is possible to obtain an advantageous effect of improving the operational stability and operational efficiency of the fuel cell stack.

In particular, according to an embodiment of the present disclosure, a separate cooling fan or the like for supplying air for cooling the fuel cell stack is not necessarily provided, because air can enter or exit the enclosure depending on a change in volume of the fuel cell stack. Therefore, it is possible to obtain an advantageous effect of simplifying the structure and improving the spatial utilization and a degree of design freedom.

According to an exemplary embodiment of the present disclosure, a fuel cell module may include a filter member provided in the enclosure while covering the vent hole and configured to filter the air introduced into the vent hole.

### BRIEF DESCRIPTION OF THE DRAWINGS

The above and other features and other advantages of embodiments of the present disclosure can be more clearly understood from the following detailed description taken in conjunction with the accompanying drawings, in which:

FIG. 1 is a view of a fuel cell module according to an embodiment of the present disclosure;

FIG. 2 is an exploded perspective view of a fuel cell module according to an embodiment of the present disclosure;

FIGS. 3 and 4 are views of an elastic member of a fuel cell module according to an embodiment of the present disclosure;

FIGS. 5 and 6 are views for explaining states in which a volume of a fuel cell module according to an embodiment of the present disclosure is decreased;

FIGS. 7 and 8 are views for explaining states in which a volume of a fuel cell module according to an embodiment of the present disclosure is increased;

FIGS. 9 to 11 are views for explaining a process of assembling a fuel cell module according to an embodiment of the present disclosure; and

FIG. 12 is a view of a modified example of a seating groove in a fuel cell module according to an embodiment of the present disclosure.

### DETAILED DESCRIPTION OF ILLUSTRATIVE EMBODIMENTS

Hereinafter, exemplary embodiments of the present disclosure will be described in detail with reference to the accompanying drawings.

However, the technical spirit of the present disclosure is not necessarily limited to some embodiments described herein but may be implemented in various different forms. One or more of the constituent elements in the embodiments may be selectively combined and substituted for use within the scope of the technical spirit of the present disclosure.

In addition, unless otherwise specifically and explicitly defined and stated, the terms (including technical and scientific terms) used in the embodiments of the present disclosure may be construed as the meaning which may be commonly understood by the person with ordinary skill in the art to which the present disclosure pertains. The meanings of the commonly used terms such as the terms defined in dictionaries may be interpreted in consideration of the contextual meanings of the related technology.

In addition, the terms used in the embodiments of the present disclosure are for explaining the embodiments, not for necessarily limiting the present disclosure.

In the present specification, unless particularly stated otherwise, a singular form may also include a plural form. The expression “at least one (or one or more) of A, B, and C” may include one or more of all combinations that can be made by combining A, B, and C.

In addition, the terms such as “first,” “second,” “A,” “B,” “(a),” and “(b)” may be used to describe constituent elements of the embodiments of the present disclosure. These terms can be used merely for the purpose of discriminating one constituent element from another constituent element, and the nature, the sequences, or the orders of the constituent elements are not necessarily limited by such terms.

Further, when one constituent element is described as being “connected”, “coupled”, or “attached” to another constituent element, one constituent element may be connected, coupled, or attached directly to another constituent element or connected, coupled, or attached to another constituent element through still another constituent element interposed therebetween.

In addition, the expression “one constituent element is provided or positioned above (on) or below (under) another constituent element” includes not only a case in which the two constituent elements are in direct contact with each other, but also a case in which one or more other constituent elements are provided or positioned between the two constituent elements. The expression “above (on)” or “below (under)” may mean a downward direction as well as an upward direction based on one constituent element.

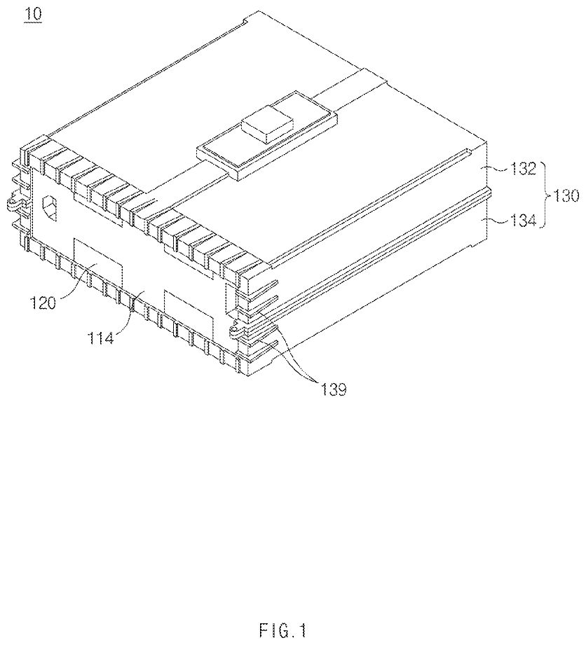

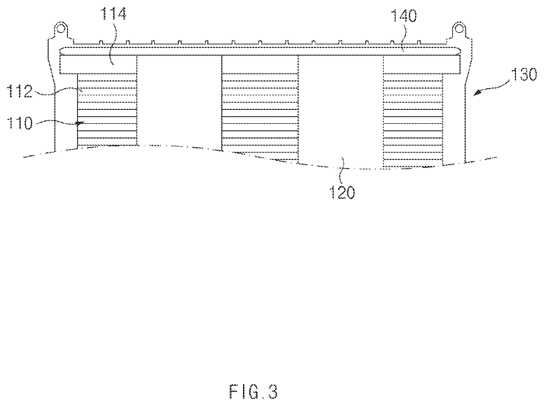

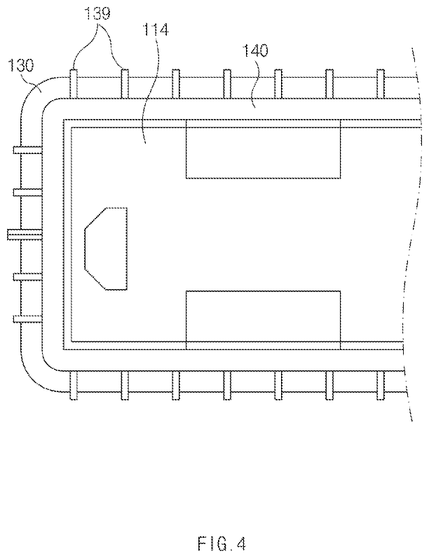

With reference to FIGS. 1 to 12, a fuel cell module 10 according to an embodiment of the present disclosure includes a fuel cell stack 110 implemented by stacking a plurality of unit cells 112, endplates 114 configured to cover ends of the fuel cell stack 110 based on a stacking direction of the unit cells 112, clamp members 120 configured to surround the fuel cell stack 11o and support the fuel cell stack 11o, an enclosure 130 configured to surround the fuel cell stack 11o and the clamp member 120, and elastic members 140 provided to be elastically compressible between the ends of the endplates 114 and the enclosure 130 in the stacking direction of the unit cells 112, the elastic members 140 being each configured to define a variable volume space 140 provided between the end of the endplate 114 and the enclosure 130 and having a volume that varies depending on a change in volume of the fuel cell stack 110.

For reference, the fuel cell module 10 according to the embodiment of the present disclosure may be applied to various mobility vehicles such as automobiles, ships, and airplanes. The present disclosure is not restricted or limited by the types and properties of subjects (mobility vehicles) to which the fuel cell module 10 is applied.

Hereinafter, an example will be described in which the fuel cell module 10 according to the embodiment of the present disclosure is applied to an aerial mobility vehicle.

The fuel cell stack 110 refers to a kind of power generation device that generates electrical energy through a chemical reaction of fuel (e.g., hydrogen), and the fuel cell stack 11o may be configured by stacking several tens or hundreds of unit cells (fuel cells) 112 in series in a reference stacking direction.

The unit cell 112 may have various structures capable of producing electricity by means of an oxidation-reduction reaction between fuel (e.g., hydrogen) and an oxidant (e.g., reaction air). The present disclosure is not restricted or limited by the structure of the unit cell 112.

According to the exemplary embodiment of the present disclosure, the unit cell 112 may include a membrane electrode assembly (MEA, not illustrated) and separators (not illustrated) stacked on two opposite surfaces of the membrane electrode assembly.

The membrane electrode assembly (MEA) is configured to generate electricity through an oxidation-reduction reaction between fuel (e.g., hydrogen), which is a first reactant gas, and an oxidant (e.g., air) which is a second reactant gas.

The membrane electrode assembly may be variously changed in structure and material in accordance with required conditions and design specifications. The present disclosure is not restricted or limited by the structure and material of the membrane electrode assembly.

For example, the membrane electrode assembly may include an electrolyte membrane through which hydrogen ions move, and catalyst electrode layers attached to two opposite sides of the electrolyte membrane. The electrochemical reactions occur in the catalyst electrode layers. In addition, gas diffusion layers (GDLs) (not illustrated) may be positioned at two opposite sides of the membrane electrode assembly. The gas diffusion layers serve to uniformly distribute the reactant gases and transfer generated electrical energy.

The separator serves not only to block air and hydrogen, which are the reactant gases, but to define flow paths for moving the reactant gases and a coolant and transmit electric current to an external circuit.

In addition, the separators may also serve to distribute heat, which is generated in the unit cell 112, to the entire unit cell 112, and the excessively generated heat may be discharged to the outside by the coolant flowing along cooling flow paths (not illustrated) between the separators.

The separators are configured to supply the first reactant gas (e.g., hydrogen) and the second reactant gas (e.g., air) to the membrane electrode assembly, and positioned to be in close contact with one surface and the other surface of the membrane electrode assembly in a stacking direction of the unit cells 112.

For example, the separator (e.g., a first separator) positioned on one surface of the membrane electrode assembly may be any one of an anode separator configured to define a flow path for fuel (e.g., hydrogen) which is the first reactant gas and a cathode separator configured to define a flow path for an oxidant (e.g., air) which is the second reactant gas. Further, the separator (e.g., a second separator) positioned on the other surface of the membrane electrode assembly may be the other of the anode separator and the cathode separator.

For example, the first separator may be in close contact with one surface of the membrane electrode assembly. The first channel (not illustrated) through which the first reactant gas (e.g., hydrogen) flows may be provided in one surface of the first separator that faces the membrane electrode assembly, and a cooling channel (not illustrated) through which the coolant flows may be provided in the other surface of the first separator.

The second separator may be in close contact with the other surface of the membrane electrode assembly. The second channel (not illustrated) through which the second reactant gas (e.g., air) flows may be provided in one surface of the second separator that faces the membrane electrode assembly, and a cooling channel (not illustrated) through which the coolant flows may be provided in the other surface of the second separator.

For reference, hydrogen, which is the fuel, and air, which is the oxidant, may be supplied to an anode (not illustrated) and a cathode (not illustrated) of the membrane electrode assembly, respectively, through the channels (not illustrated) in the first separator and the second separator. The hydrogen may be supplied to the anode, and the air may be supplied to the cathode.

The hydrogen supplied to the anode is decomposed into hydrogen ions (protons) and electrons by catalysts in the electrode layers provided at two opposite sides of the electrolyte membrane. Only the hydrogen ions are selectively transmitted to the cathode through the electrolyte membrane, which is a cation exchange membrane, and at the same time, the electrons are transmitted to the cathode through the gas diffusion layer and the separator which are conductors.

At the cathode, the hydrogen ions supplied through the electrolyte membrane and the electrons transmitted through the separator meet oxygen in the air supplied to the cathode by an air supply device, thereby creating a reaction producing water. As a result of the movement of the hydrogen ions, the electrons flow through external conductive wires, and the electric current is generated as a result of the flow of the electrons.

The endplates 114 can serve to protect the fuel cell stack 110 from external impact or the like and define outermost peripheral sides of the fuel cell stack 110.

The endplate 114 may be made of various materials in accordance with required conditions and design specifications. The present disclosure is not restricted or limited by the material of the endplate 114. For example, the endplate 114 may be made of a typical metallic material.

The endplate 114 may have various structures capable of covering an outermost peripheral end (outer surface) of the fuel cell stack 110. The present disclosure is not restricted or limited by the structure and shape of the endplate 114.

For example, the endplate 114 may have a structure corresponding to the unit cell 112. The outer surfaces of the unit cells 112 (the outermost peripheral end of the fuel cell stack) may be entirely covered by the endplates 114.

In addition, a bypass plate (not illustrated) may be provided between the endplate 114 and the fuel cell stack 110 (the outermost peripheral end of the fuel cell stack) and serve to remove differential pressure between the first reactant gas (e.g., hydrogen) and the second reactant gas (e.g., air) introduced into the fuel cell stack 110.

The clamp member 120 is configured to ensure sealability (fastening pressure) of the fuel cell stack 110. The respective unit cells 112 may be in close contact with one another by preset fastening pressure applied by the clamp member 120.

The clamp member 120 may be variously changed in number and mounting position in accordance with required conditions and design specifications. The present disclosure is not restricted or limited by the number of clamp members 120 and the mounting position of the clamp member 120.

Hereinafter, an example will be described in which a total of four clamp members 120 are fastened to the fuel cell stack 11o, two clamp members 120 for each of upper and lower sides of the fuel cell stack 110.

The clamp member 120 may have various structures capable of fastening the plurality of unit cells 112. The present disclosure is not restricted or limited by the structure of the clamp member 120.

According to an exemplary embodiment of the present disclosure, the clamp member 120 may include a clamp body 122 configured to cover at least part of an outer surface of the fuel cell stack 110 in the stacking direction of the unit cells 112, and clamp hooks 124 connected to ends of the clamp body 122, configured to cover at part of outer surfaces of the endplates 114, and directly restrained by the endplates 114.

The clamp body 122 may have various structures capable of covering the outer surface of the fuel cell stack 110 in the stacking direction of the unit cells 112. The present disclosure is not restricted or limited by the structure and shape of the clamp body 122.

For example, the clamp body 122 may be provided in the form of a straight strap (band) having a length corresponding to the fuel cell stack 110 (i.e., a length in a length direction of the fuel cell stack).

According to an embodiment of the present disclosure, the clamp body may have a curved shape (e.g., an S shape or a C shape) or other shapes.

The clamp hook 124 is connected to the end of the clamp body 122 so as to be restrained by (fastened to) the endplate 114 while covering at least part of an outer surface of the endplate 114.

For example, the clamp hook 124 may be fastened to the endplate 114 by means of a binding member such as a typical fastening bolt. According to an embodiment of the present disclosure, the clamp hook may be configured to be independently fastened (bound) to the endplate without using a separate binding member such as a separate fastening bolt.

Hereinafter, an example will be described in which the clamp hooks 124 are respectively provided at the two opposite ends of the clamp body 122 and fastened to the endplates 114 corresponding to the clamp hooks 124. For example, the clamp hooks 124, together with the clamp body 122, may define an approximately “U”-shaped cross-sectional shape.

The clamp member 120 may be made of various materials in accordance with required conditions and design specifications. The present disclosure is not restricted or limited by the material and properties of the clamp member 120.

In particular, the clamp member 120 may be made of a material capable of being elastically deformed (extended or contracted) depending on a change in volume of the fuel cell stack 110.

For example, the clamp member 120 may be made of a carbon fiber material. According to an embodiment of the present disclosure, the clamp member may be made of a typical metallic material or other materials.

The enclosure 130 is configured to at least partially, mostly, or completely surround the fuel cell stack 110 to protect the fuel cell stack 110 from external impact or the like.

Hereinafter, an example will be described in which the enclosure 130 is configured to surround an entire lateral side of the fuel cell stack 110. Alternatively, the enclosure 130 may be configured to surround a part of the lateral side of the fuel cell stack 110.

The enclosure 130 may have various structures capable of surrounding the fuel cell stack 110. The present disclosure is not restricted or limited by the structure and shape of the enclosure 130.

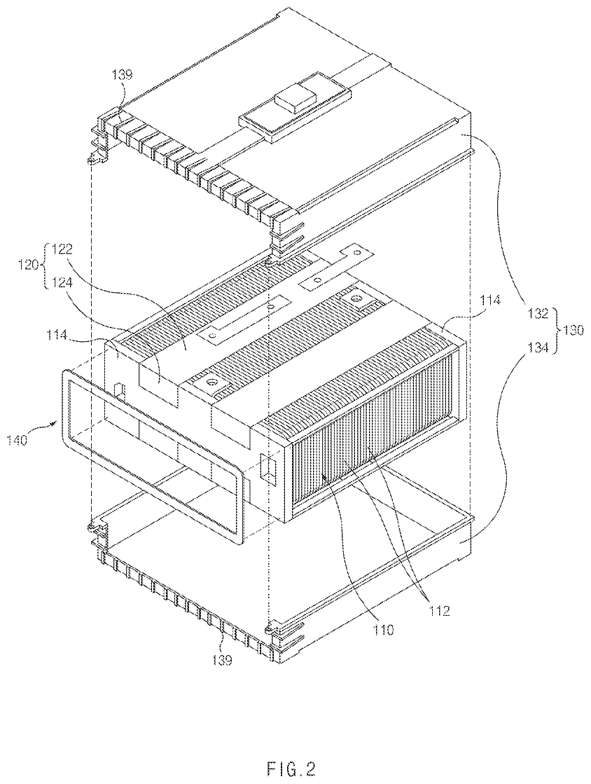

According to an exemplary embodiment of the present disclosure, the enclosure 130 may include a first housing 132 configured to surround a part (e.g., the upper portion based on FIG. 2) of the fuel cell stack 11o, and a second housing 134 configured to surround another part (e.g., the lower portion based on FIG. 2) of the fuel cell stack 110. The first housing 132 and the second housing 134 may collectively define an accommodation space that accommodates the fuel cell stack 110.

For example, the first housing 132 and the second housing 134 may collectively define an approximately quadrangular box shape.

Further, the enclosure 130 may be configured to surround a part or the entirety of the outer surface of the endplate 114 in accordance with required conditions and design specifications.

For example, an approximately central portion of any one (e.g., the left endplate based on FIG. 2) of the pair of endplates 114 provided at the two opposite ends of the fuel cell stack 11o, except for an edge portion thereof, may be exposed to the outside of the enclosure 130. The other (e.g., the right endplate in FIG. 2) of the pair of endplates 114 provided at the two opposite ends of the fuel cell stack 110 may be entirely covered by the enclosure 130.

According to an embodiment of the present disclosure, both of the endplates provided at the two opposite ends of the fuel cell stack may be exposed to the outside of the enclosure (e.g., the left and right endplates are partially exposed to the outside of the enclosure). Alternatively, both of the endplates provided at the two opposite ends of the fuel cell stack may be covered by the enclosure.

In the embodiment of the present disclosure illustrated and described above, the example has been described in which the enclosure 130 includes the two housings. However, according to another embodiment of the present disclosure, only a single housing may constitute the enclosure, or three or more housings may constitute the enclosure.

With reference to FIGS. 2 to 8, the elastic member 140 is provided to be elastically compressible between the end of the endplate 114 and the enclosure 130 in the stacking direction of the unit cell 112. The elastic member 140 is configured to define the variable volume space 140 provided between the end of the endplate 114 and the enclosure 130 and having a volume that varies depending on a change in volume of the fuel cell stack 110.

The elastic member 140 can be configured to minimize local deformation (bending deflection) of the endplate 114 and apply entirely uniform surface pressure and fastening pressure to the fuel cell stack 110 when the fuel cell stack 110 is elastically deformed by a change in volume thereof (e.g., as the fuel cell stack 110 is extended or contracted in the stacking direction of the unit cells).

For reference, in an embodiment of the present disclosure, the configuration in which the volume of the variable volume space 140 varies depending on a change in volume of the fuel cell stack 110 may be defined as a configuration in which a length (or width) of the variable volume space 140 in the stacking direction of the unit cells varies depending on a change in volume of the fuel cell stack 110 (e.g., a change in length of the fuel cell stack in the stacking direction of the unit cells).

According to an exemplary embodiment of the present disclosure, the elastic members 140 may be respectively provided at the two opposite ends of the fuel cell stack (e.g., the end of the left endplate and the end of the right endplate).

According to an embodiment of the present disclosure, the elastic member may be provided only at any one of the two opposite ends of the fuel cell stack (e.g., any one of the end of the left endplate and the end of the right endplate).

The elastic member 140 may have various structures capable of being elastically compressible and restorable (expandable and contractible) between the end of the endplate 114 and the enclosure 130. The present disclosure is not restricted or limited by the structure of the elastic member 140.

According to an exemplary embodiment of the present disclosure, the elastic member 140 may include a first support portion 142 provided to be elastically in contact with the enclosure 130, a second support portion 144 spaced apart from the first support portion 142 and provided to be elastically in contact with the endplate 114, and a connection portion 146 configured to connect the first support portion 142 and the second support portion 144.

For example, the first support portion 142, the second support portion 144, and the connection portion 146 may collectively define an approximately “U” shape.

According to an embodiment of the present disclosure, the first support portion, the second support portion, and the connection portion may collectively define an approximately “H” shape or other shapes.

The elastic member 140 may be made of various materials in accordance with required conditions and design specifications. The present disclosure is not restricted or limited by the material and properties of the elastic member 140.

According to an exemplary embodiment of the present disclosure, the elastic member 140 may be made of carbon fiber reinforced plastic (CFRP).

According to an embodiment of the present disclosure, the elastic member may be made of a typical metallic material (e.g., stainless steel) or other materials.

In particular, the elastic member 140 may be provided in the form of a continuous ring provided along an edge of the endplate 114.

For example, the elastic member 140 may be provided in the form of an approximately quadrangular ring corresponding to the endplate 114.

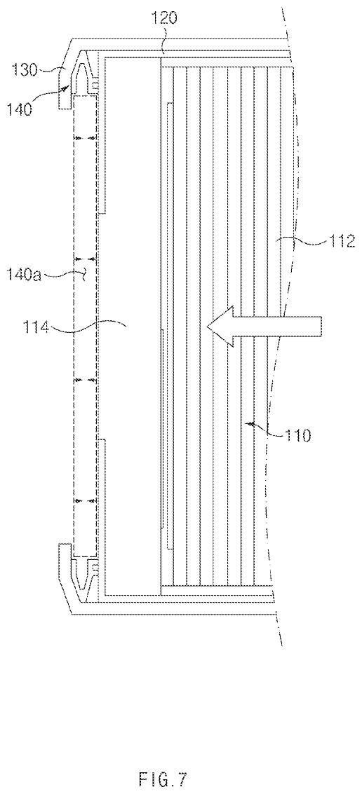

With the above-mentioned configuration, when the length of the fuel cell stack 11o increases (the length of the fuel cell stack in the stacking direction of the unit cells increases) in accordance with a change in volume of the fuel cell stack 11o, the second support portion 144 is elastically moved toward the first support portion 142 by the endplate 114, as illustrated in FIG. 7, such that the elastic member 140 may be compressed, and the outer surface (a surface facing the elastic member) of the endplate 114 may be elastically supported by the elastic member 140.

Among other things, the elastic member 140 may be provided in the form of a continuous ring provided along the edge of the endplate 114 and elastically support the entire edge of the endplate 114, thereby suppressing local deformation (bending deflection) of the endplate 114 caused by a change in volume of the fuel cell stack 110.

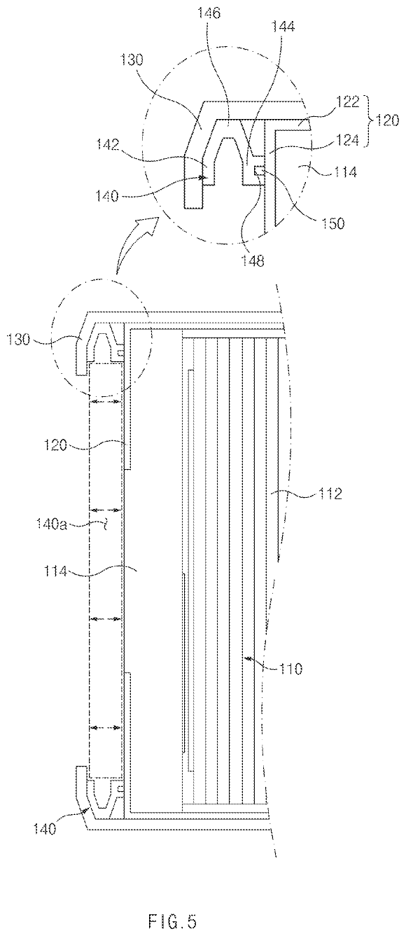

In contrast, when the length of the fuel cell stack 110 decreases (the length of the fuel cell stack in the stacking direction of the unit cells decreases) in accordance with a change in volume of the fuel cell stack 11o, the second support portion 144 is moved away from the first support portion 142, as illustrated in FIG. 5, such that the elastic member 140 may be restored, and the outer surface (the surface facing the elastic member) of the endplate 114 may be elastically supported by the elastic member 140.

As described above, according to an embodiment of the present disclosure, the elastic member 140 can be provided between the end of the endplate 114 and the enclosure 130 based on the stacking direction of the unit cells 112, and the endplate 114 can be elastically supported by the elastic member 140 when the length of the fuel cell stack 110 varies depending on a change in volume of the fuel cell stack 11o, such that local deformation (bending deflection) of the endplate 114 may be minimized. Therefore, it is possible to obtain an advantageous effect of applying entirely uniform surface pressure and fastening pressure to the fuel cell stack 110 and improving durability of the fuel cell stack 110.

With reference to FIGS. 1 and 2, according to an exemplary embodiment of the present disclosure, the fuel cell module 10 may include reinforcement ribs 139 provided on the enclosure 130 while corresponding to the elastic member 140.

The reinforcement ribs 139 can be configured to ensure structural rigidity of the portion of the enclosure 130 that is in contact with the elastic member 140.

For example, the reinforcement ribs 139 may be provided on an outer surface of the enclosure 130 and correspond to the elastic member 140. According to another embodiment of the present disclosure, the reinforcement ribs may be provided on an inner surface of the enclosure.

The reinforcement rib 139 may have various structures capable of improving structural rigidity of the enclosure 130. The present disclosure is not restricted or limited by the structure and shape of the reinforcement rib 139.

For example, the reinforcement rib 139 may be provided on an edge portion of an end of the enclosure and have an approximately “L” shape. A plurality of reinforcement ribs 139 may be provided to be spaced apart from one another along the edge of the enclosure.

As described above, according to an embodiment of the present disclosure, the reinforcement ribs 139 can be provided on the enclosure 130 so as to correspond to the elastic member 140, such that the structural rigidity of the portion of the enclosure 130, which is in contact with the elastic member 140, may be ensured. Therefore, it is possible to obtain an advantageous effect of minimizing deformation of the endplate 114 by using an elastic force of the elastic member 140 and more stably maintaining an arrangement state and elastic supporting performance of the elastic member 140.

With reference to FIG. 5, according to an exemplary embodiment of the present disclosure, the fuel cell module 10 may include a sealing member 150 provided between the elastic member 140 and the endplate 114.

The sealing member 150 can be configured to perform sealing, waterproof, and dustproof functions together with the elastic member 140.

The sealing member 150 may have various structures capable of sealing a gap between the elastic member 140 and the endplate 114. The present disclosure is not restricted or limited by the shape and structure of the sealing member 150.

For example, the sealing member 150 may have an approximately quadrangular ring shape and interposed between the elastic member 140 and the endplate 114.

The sealing member 150 may be made of an elastic material such as silicone or urethane. The present disclosure is not restricted or limited by the material and properties of the sealing member 150.

As described above, according to an embodiment of the present disclosure, the sealing member 150 can be provided between the elastic member 140 and the endplate 114. Therefore, it is possible to obtain an advantageous effect of minimizing a leak of a reactant gas and a coolant through the gap between the elastic member 140 and the endplate 114 and minimizing introduction of foreign substances such as dust.

According to an exemplary embodiment of the present disclosure, the fuel cell module 10 may include a seating groove 148 provided between the elastic member 140 and the endplate 114.

For example, with reference to FIG. 5, the seating groove 148 may be provided in one surface of the elastic member 140 that faces the endplate 114, and the sealing member 150 may be seated in the seating groove 148.

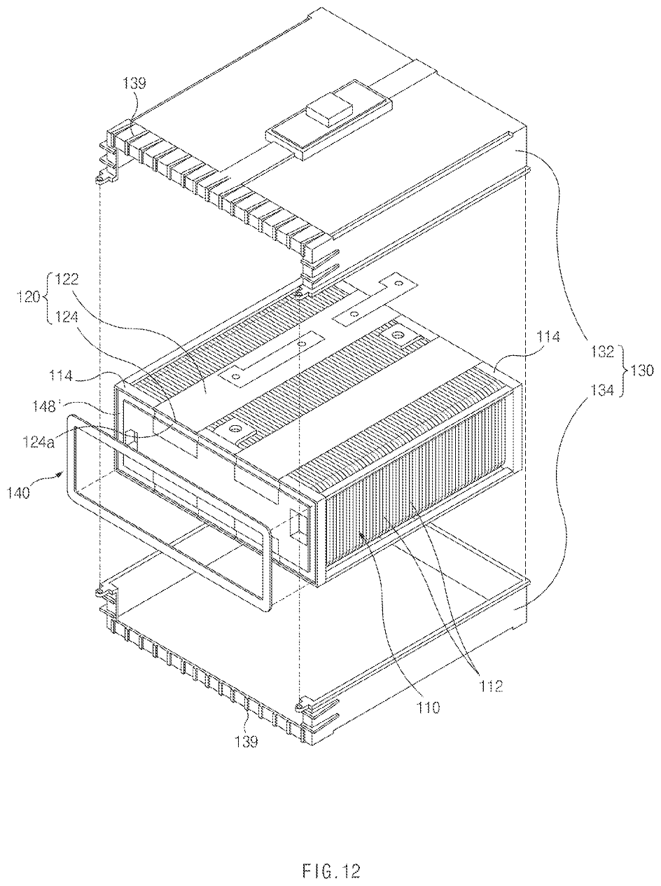

As another example, with reference to FIG. 12, a seating groove 148′ may be provided in one surface of the endplate 114 that faces the elastic member 140, and the sealing member 150 may be seated in the seating groove 148′.

In addition, with reference to FIG. 12, according to an exemplary embodiment of the present disclosure, the fuel cell module 10 may include a guide groove 124a provided in an outer surface of the clamp hook 124, which faces the elastic member 140, so that the guide groove 124a is continuously connected to (communicates with) the seating groove 148′. The seating groove 148′ and the guide groove 124a may collectively accommodate the entire elastic member 140.

As described above, according to an embodiment of the present disclosure, the seating groove 148 and/or 148′ is provided between the elastic member 140 and the endplate 114, and the sealing member 150 is seated in the seating groove 148 and/or 148′. Therefore, it is possible to obtain an advantageous effect of stably maintaining the arrangement state of the sealing member 150 and stably ensuring the sealing performance.

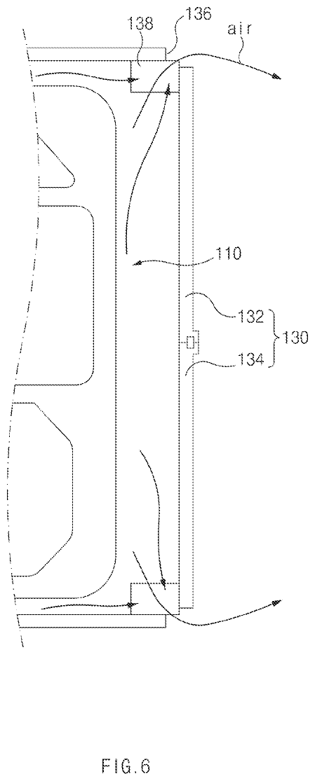

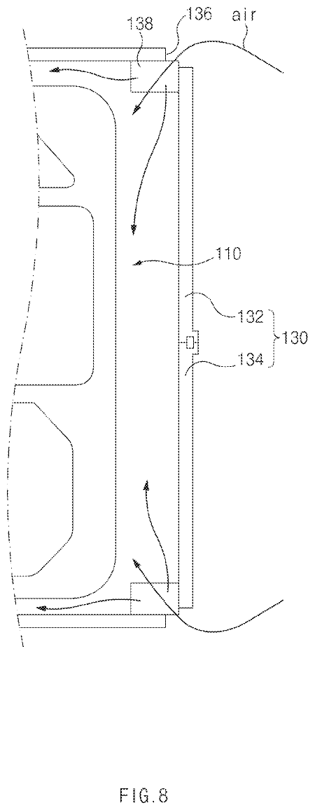

According to an exemplary embodiment of the present disclosure, as illustrated in FIGS. 6 and 8, the fuel cell module 10 may include vent holes 136 provided in the enclosure 130 so that air may enter or exit the enclosure 130 depending on a change in volume of the fuel cell stack 110.

The configuration in which air enters or exits the enclosure 130 through the vent hole 136 can include both a configuration in which outside air is introduced into the gap between the fuel cell stack 110 and the enclosure 130 through the vent hole 136 and a configuration in which air, which stagnates in the gap between the fuel cell stack 110 and the enclosure 130, is discharged to the outside of the enclosure 130 through the vent hole 136.

The vent hole 136 may have various structures through which air may be introduced or discharged. The present disclosure is not restricted or limited by the structure and shape of the vent hole 136.

For example, the vent hole 136 may be provided in the form of a straight slot provided along a lateral edge of the enclosure 130.

According to other embodiments of the present disclosure, the vent hole may have a circular shape or other shapes.

With the above-mentioned configuration, when the volume of the fuel cell stack 11o decreases (the length of the fuel cell stack in the stacking direction of the unit cells decreases), outside air with a low temperature may be introduced (sucked) into the gap between the fuel cell stack 110 and the enclosure 130 through the vent hole 136, as illustrated in FIG. 8.

In contrast, as illustrated in FIG. 6, when the volume of the fuel cell stack 11o increases (the length of the fuel cell stack in the stacking direction of the unit cells increases), the hot air in the enclosure 130 (the air that stagnates in the gap between the fuel cell stack and the enclosure) may be discharged to the outside of the enclosure 130 through the vent hole 136.

As described above, according to an embodiment of the present disclosure, the vent hole 136 can be provided in the enclosure 130, such that an effect of cooling the fuel cell stack 110 depending on a change in volume of the fuel cell stack 110 may be provided. Therefore, it is possible to obtain an advantageous effect of improving the operational stability and operational efficiency of the fuel cell stack 110.

In particular, according to an embodiment of the present disclosure, a separate cooling fan or the like for supplying air for cooling the fuel cell stack 110 is not necessarily provided, because air can enter or exit the enclosure 130 depending on a change in volume of the fuel cell stack 110. Therefore, it is possible to obtain an advantageous effect of simplifying the structure and improving the spatial utilization and a degree of design freedom.

According to an exemplary embodiment of the present disclosure, the fuel cell module 10 may include a filter member 138 provided in the enclosure 130 so as to cover the vent hole 136 and configured to filter air introduced into the vent hole 136.

The filter member 138 can be configured to filter air to be supplied (introduced) into the enclosure 130 through the vent hole 136.

The configuration in which the air to be supplied into the enclosure 130 is filtered can be a configuration in which foreign substances such as dust contained in air are filtered out by the filter member 138.

A typical dry filter or a typical paper filter (e.g., an air filter) may be used as the filter member 138. The present disclosure is not restricted or limited by the material and type of the filter member 138.

For example, the filter member 138 may be provided in the form of an approximately quadrangular block and provided on the inner surface of the enclosure 130 so as to cover the vent hole 136. According to another embodiment of the present disclosure, the filter member may be provided on the outer surface of the enclosure.

Meanwhile, the fuel cell module 10 according to an embodiment of the present disclosure may be assembled in various ways in accordance with required conditions and design specifications. The present disclosure is not restricted or limited by the method and order of assembling the fuel cell module 10.

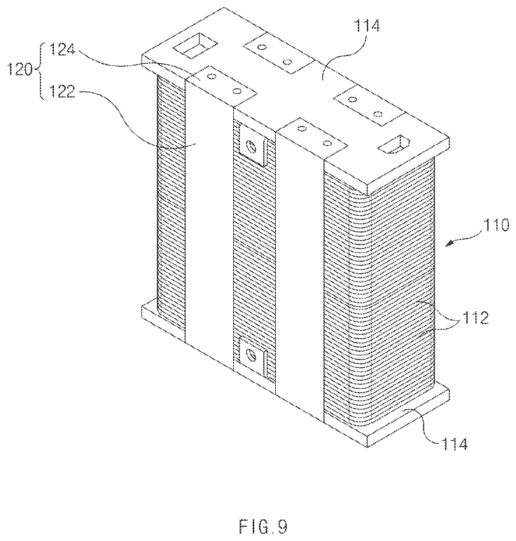

For example, with reference to FIG. 9, an endplate 114 may be positioned at an end of a fuel cell stack 110 including a plurality of unit cells 112, and then a clamp member 120 may be fastened to the endplate 114.

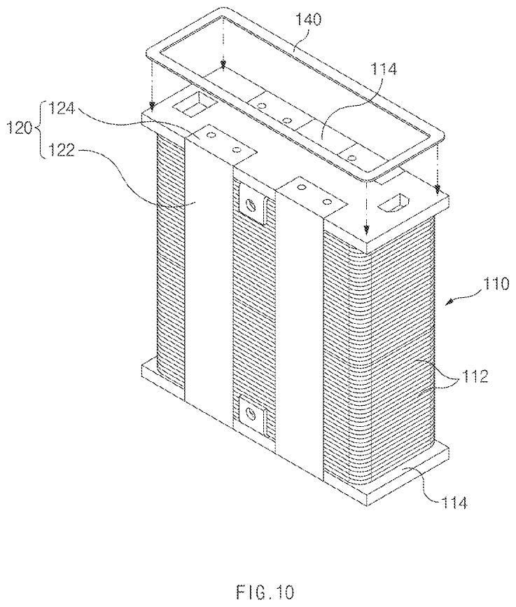

Next, as illustrated in FIG. 10, the elastic members 140 may be respectively positioned at the two opposite ends of the endplates 114.

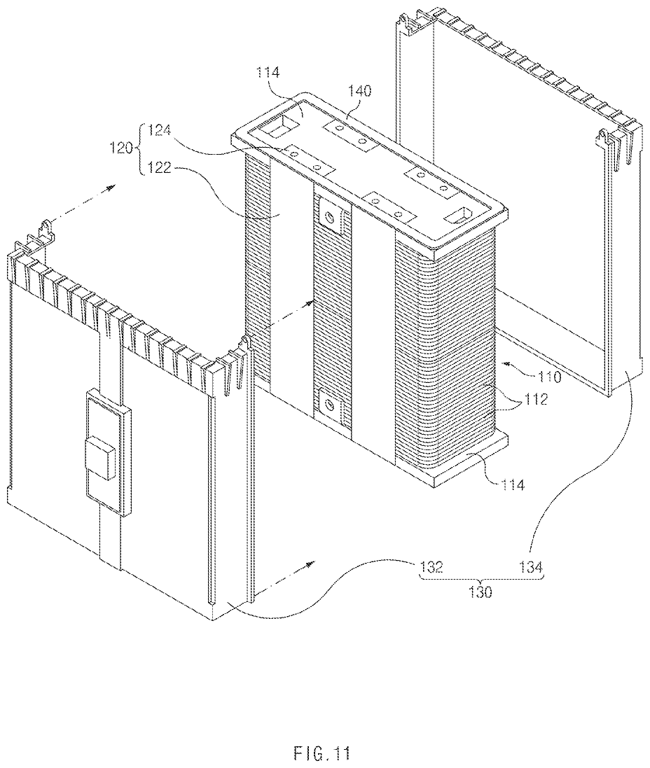

Thereafter, as illustrated in FIG. 11, the enclosure 130 can be assembled to surround the fuel cell stack 110 and the clamp member 120, such that the fuel cell module 10 may be manufactured.

As described above, according to an embodiment of the present disclosure, it is possible to obtain an advantageous effect of minimizing deformation of and damage to the fuel cell stack and improving the safety and reliability.

In particular, according to an embodiment of the present disclosure, it is possible to obtain an advantageous effect of applying entirely uniform surface pressure and fastening force to the fuel cell stack.

Among other things, according to an embodiment of the present disclosure, it is possible to obtain an advantageous effect of applying entirely uniform surface pressure and fastening pressure to the fuel cell stack when the volume of the fuel cell stack is changed.

In addition, according to an embodiment of the present disclosure, it is possible to obtain an advantageous effect of improving sealing, waterproof, and dustproof performance while ensuring the durability of the fuel cell stack.

In addition, according to an embodiment of the present disclosure, it is possible to obtain an advantageous effect of improving performance in cooling the fuel cell stack.

While embodiments have been described above, the embodiments are just illustrative and not intended to necessarily limit the present disclosure. It can be appreciated by those skilled in the art that various modifications and applications, which are not described above, may be made to the present embodiment without departing from the intrinsic features of the present embodiment. For example, the respective constituent elements specifically described in the embodiments may be modified and then carried out. Further, it can be interpreted that differences related to modifications and applications can be included in the scope of the present disclosure defined by the appended claims.

What is claimed is:

1. A fuel cell module comprising:
a fuel cell stack comprising a stack of unit cells;
an endplate configured to cover an end of the fuel cell stack based on a stacking direction of the unit cells;
a clamp member configured to extend along the stacking direction of the fuel cell stack and support the fuel cell stack;
an enclosure configured to surround the fuel cell stack and the clamp member; and
an elastic member configured to be elastically compressible between the endplate and the enclosure based on the stacking direction of the unit cells, the elastic member being configured to define a variable volume space between the endplate and the enclosure such that the variable volume varies depending on a change in volume of the fuel cell stack.

2. The module of claim 1, wherein the elastic member comprises a continuous ring located along a perimeter of the endplate.

3. The module of claim 1, wherein the elastic member comprises:
a first support portion provided to be elastically in contact with the enclosure;
a second support portion spaced apart from the first support portion and provided to be elastically in contact with the endplate; and
a connection portion configured to connect the first support portion and the second support portion.

4. The module of claim 1, further comprising a sealing member located between the elastic member and the endplate.

5. The module of claim 4, further comprising a seating groove located between the elastic member and the endplate so that the sealing member is seated in the seating groove.

6. The module of claim 5, wherein the seating groove is provided in a surface of the elastic member that faces the endplate.

7. The module of claim 5, wherein the seating groove is provided in a surface of the endplate that faces the elastic member.

8. The module of claim 1, wherein the enclosure comprises:
a first housing configured to surround a first part of the fuel cell stack; and
a second housing configured to surround a second part of the fuel cell stack.

9. The module of claim 1, further comprising a vent hole provided in the enclosure, the vent hole being configured so that air enters or exits the enclosure depending on a change in volume of the fuel cell stack.

10. The module of claim 9, further comprising a filter member provided to cover the vent hole and configured to filter the air that enters into the vent hole.

11. The module of claim 1, further comprising a reinforcement rib provided on the enclosure while corresponding to the elastic member.

12. The module of claim 7, wherein the clamp member comprises:
a clamp body configured to extend along an outer surface of the fuel cell stack in the stacking direction of the unit cells; and
a clamp hook coupled to an end of the clamp body and configured to cover at least part of an outer surface of the endplate.

13. The module of claim 12, further comprising a guide groove provided in an outer surface of the clamp hook, such that the guide groove faces the elastic member, so as to be continuously connected to the seating groove and configured such that the elastic member is seated in the guide groove.

14. The module of claim 1, wherein the elastic member comprises carbon fiber reinforced plastic (CFRP).

15. A fuel cell module comprising:
a fuel cell stack comprising a stack of unit cells;
an endplate coupled to an end of the fuel cell stack based on a stacking direction of the unit cells;
a clamp member configured to extend along the stacking direction of the fuel cell stack and support the fuel cell stack;
an enclosure structure configured to house the fuel cell stack and the clamp member; and
an elastic member configured to be elastically compressible between the endplate and the enclosure structure based on the stacking direction of the unit cells, the elastic member being configured to define a variable volume space between the endplate and the enclosure structure such that the variable volume varies depending on a change in volume of the fuel cell stack, wherein the elastic member comprises:
a first support portion provided to be coupled to the enclosure,
a second support portion spaced apart from the first support portion and provided to be coupled to the endplate, and
a connection portion configured to couple the first support portion and the second support portion.

16. The module of claim 15, further comprising:
a sealing member located between the elastic member and the endplate;
a vent hole provided in the enclosure, the vent hole being configured so that air enters or exits the enclosure depending on a change in volume of the fuel cell stack; and
a filter member provided to cover the vent hole and configured to filter the air that enters via the vent hole.

17. A fuel cell module comprising:
a fuel cell stack comprising a stack of unit cells;
an endplate coupled to an end of the fuel cell stack based on a stacking direction of the unit cells;
a clamp member configured to extend along the stacking direction of the fuel cell stack and support the fuel cell stack, wherein the clamp member comprises:
a clamp body configured to extend along an outer surface of the fuel cell stack in the stacking direction of the unit cells, and
a clamp hook coupled to an end of the clamp body and configured to cover at least part of an outer surface of the endplate;
an enclosure structure configured to house the fuel cell stack and the clamp member, wherein the enclosure structure comprises:
a first housing configured to cover a first part of the fuel cell stack, and
a second housing configured to cover a second part of the fuel cell stack;
an elastic member configured to be elastically compressible between the endplate and the enclosure, the elastic member being configured to define a variable volume space between the endplate and the enclosure such that the variable volume varies along the stacking direction depending on a change in volume of the fuel cell stack, wherein the elastic member comprises:
a first support portion coupled to the enclosure,
a second support portion spaced apart from the first support portion and coupled to the endplate, and
a connection portion configured to couple the first support portion and the second support portion;
a sealing member located between the elastic member and the endplate;
a vent hole provided in the enclosure, the vent hole being configured so that air enters or exits the enclosure depending on a change in volume of the fuel cell stack;
a filter member provided to cover the vent hole and configured to filter the air that enters via the vent hole; and
a seating groove located between the elastic member and the endplate so that the sealing member is seated in the seating groove.

18. The module of claim 17, wherein the elastic member comprises a continuous ring located along an edge of the endplate.

19. The module of claim 17, wherein the seating groove is provided in a surface of the elastic member that faces the endplate.

20. The module of claim 17, wherein the seating groove is provided in a surface of the endplate that faces the elastic member, and wherein the clamp hook comprises a guide groove formed in an outer surface of the clamp hook, such that the guide groove faces the elastic member, so as to be continuously connected to the seating groove and configured such that one or both of the elastic member and sealing member is seated in the guide groove.
